(19) United States
(12) Patent Application Publication
(10) Pub. No.: US 2024/0269824 A1
(43) Pub. Date: Aug. 15, 2024

(54) FLEXIBLE EXOSKELETON FRAMES AND ARM SUPPORT SYSTEMS AND METHODS FOR USING THEM

(71) Applicant: LEVITATE TECHNOLOGIES, INC., San Diego, CA (US)

(72) Inventor: Mark C. Doyle, Del Mar, CA (US)

(21) Appl. No.: 18/414,972

(22) Filed: Jan. 17, 2024

Related U.S. Application Data
(63) Continuation of application No. PCT/US22/37579, filed on Jul. 19, 2022.
(60) Provisional application No. 63/223,490, filed on Jul. 19, 2021.

(51) Int. Cl. B25J 9/00; A61H 1/02

(52) U.S. Cl. CPC B25J 9/0006; A61H 1/0274; A61H 1/0292

(57) ABSTRACT

A frame for an exoskeleton is provided that includes first and second independent spine structures, each spine structure having a substantially vertical pivot axis at a first end and a hip contact strut at a second end, the spine structures configured to articulate independently relative to each other in multiple planes, angles, and directions.

### RELATED APPLICATION DATA

The present application is a continuation of International Application No. PCT/US2022/037579, filed Jul. 19, 2022, which claims benefit of U.S. provisional application Ser. No. 63/223,490, filed Jul. 19, 2021, the entire disclosures of which are expressly incorporated by reference herein.

### TECHNICAL FIELD

The present application is related to systems, devices, and methods for supporting a user's arms, for example, to adaptive arm support systems that support one or both of a user's arms, while allowing substantially free motion, e.g., to allow the user to perform one or more tasks for extended periods of time with one or both arms extended.

### BACKGROUND

Exoskeletons to support the arms of workers have been deployed in industry for various tasks requiring the user's arms to be raised or outstretched. Some direct the weight of the user's arms, and the load they are holding, through a substantially rigid frame onto the torso and hips of the user, thereby reducing the load on the person's shoulders, upper back, upper arms, and lower back. These substantially rigid frames, while very effective in transmitting load past the shoulders, upper back, upper arms, and lower back, can also impede certain motions such as twisting and bending at the waist. Impeding these motions can make certain jobs more difficult.

Therefore, there is a need for a frame for an exoskeleton that provides desired load reduction while allowing the user to more easily twist and bend their torso or otherwise provide increased flexibility while the user moves.

### SUMMARY

The present application is directed to systems, devices, and methods for supporting a user's arms, for example, to adaptive arm support systems that support one or both of a user's arms, while allowing substantially free motion, e.g., to allow the user to perform one or more tasks for extended periods of time with one or both arms extended. More particularly, the present application is directed to flexible frames for exoskeletons and/or arm support systems including such exoskeletons.

In accordance with one example, a frame for an exoskeleton is provided that includes first and second independent spine structures, each spine structure having a substantially vertical pivot axis at a first end and a hip contact strut at a second end, the spine structures configured to articulate independently relative to each other in multiple planes, angles, and directions.

In accordance with another example, a frame is provided for an exoskeleton that includes a pair of elongate spine members comprising lower ends and upper ends, each aligned generally along respective vertical axes; pivot assemblies extending from the upper ends of respective spine members such that the pivot assemblies define horizontal axes; an anti-rotation member pivotally coupled to the lower ends of the spine members to prevent the horizontal axes from changing horizontally as the spine members move; and a lumbar reaction member pivotally coupled to the upper ends of the spine members to provide a linkage that accommodates movement of a user wearing the frame while transferring loads from the pivot assemblies to the torso of the user.

In accordance with still another example, a frame is provided for an exoskeleton that includes a pair of elongate spine members comprising lower ends and upper ends aligned generally along vertical axes; a pivot assembly extending from an upper end of a first spine member of the elongate spine members such that the pivot assembly defines a horizontal axis; an anti-rotation member pivotally coupled to the lower ends of the spine members to prevent the spine members from rotating about the vertical axes to prevent the horizontal axis from changing horizontally as the spine members move; a lumbar reaction member pivotally coupled to the upper ends of the spine members to provide a linkage that accommodates movement of a user wearing the frame while transferring loads from the pivot assemblies to the torso of the user; and a shoulder bracket coupled to the pivot assembly such that the shoulder bracket rotates about a vertical axis within a generally horizontal plane to accommodate movement of an arm support coupled to the shoulder bracket.

In accordance with yet another example, an arm support system is provided that includes an exoskeleton including a frame comprising a pair of elongate spine members comprising lower ends and upper ends aligned generally along vertical axes; a first pivot assembly extending from the upper end of a first spine member such that the first pivot assembly defines a horizontal axis; an anti-rotation member pivotally coupled to the lower ends of the spine members to prevent the horizontal axis from changing horizontally as the spine members move; and a lumbar reaction member pivotally coupled to the upper ends of the spine members to provide a linkage that accommodates movement of a user wearing the frame while transferring loads from the pivot assemblies to the torso of the user; a first shoulder bracket coupled to the first pivot assembly such that the first shoulder bracket rotates within a generally horizontal plane; a first arm support comprising an arm rest and coupled to the first shoulder bracket such that the first arm support rotates within a generally vertical plane to accommodate vertical movement of an arm within the arm rest; and one or more compensation elements coupled to the first arm support to apply an offset force to at least partially offset a gravitational force acting on the arm within the arm rest during vertical movement of the arm and the first arm support follows the movement of the user's arm.

Other aspects and features of the present invention will become apparent from consideration of the following description taken in conjunction with the accompanying drawings.

### BRIEF DESCRIPTION OF THE DRAWINGS

It is Believed the Present Invention Will be Better Understood from the Following Description of Certain Examples Taken in Conjunction with the Accompanying Drawings, in which Like Reference Numerals Identify the Same Elements and in which:

FIG. 1A shows an example of a flexible exoskeleton including a frame worn by a user and arm supports carrying arm rests and cassettes that include one or more compensation elements for supporting the user's arms and accommodating movement of the arms.

FIG. 1B shows the exoskeleton of FIG. 1A with the arm supports removed from the frame

FIGS. 2A and 2B are perspective and top views, respectively, of the frame of FIGS. 1A and 1B without the arm supports.

FIG. 3 shows various adjustments that can be made to the frame of FIGS. 1A and 1B to accommodate the anatomy of an individual user.

FIGS. 4A and 4B show various movable links or joints that may be provided on the frame of FIGS. 1A and 1B to accommodate movement of a user wearing the frame.

FIGS. 5A and 5B show additional movements that may be accommodated when the frame of FIGS. 1A and 1B is worn by a user.

The drawings are not intended to be limiting in any way, and it is contemplated that various examples of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

Before the examples are described, it is to be understood that the invention is not limited to particular examples described, as such may, of course, vary. It is also to be understood that the terminology used herein is for the purpose of describing particular examples only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, some potential and exemplary methods and materials are now described.

It must be noted that as used herein and in the appended claims, the singular forms “a,” “an,” and “the” include plural referents unless the context clearly dictates otherwise. Thus, for example, reference to “a compound” includes a plurality of such compounds and reference to “the polymer” includes reference to one or more polymers and equivalents thereof known to those skilled in the art, and so forth.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

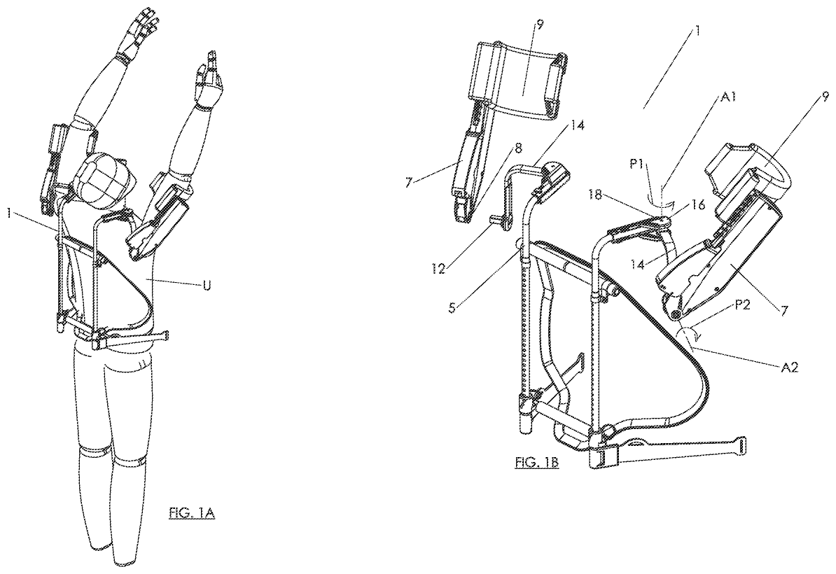

Turning to the drawings, FIGS. 1A and 1B show a perspective view of an exoskeleton 1 designed to be worn on the upper body of a user U, and to support the arm(s) of the user, e.g., similar to the systems disclosed in U.S. Pat. Nos. 9,205,017, 9,737,374, 9,427,865, and 10,617,551, the entire disclosures of which are expressly incorporated by reference herein.

As shown, the exoskeleton 1 includes three basic components: a frame 5, an arm support cassette 7 (for one or both arms, one shown for each arm), and an armrest 9 (again for one or both arms). The cassette 7 supports the user's upper arm through a spring mechanism housed within the cassette 7, e.g., similar to the systems disclosed in the references incorporated by reference herein. The armrest 9 is attached to the cassette 7 and transmits the supporting force from the cassette 7 to the user's arm. The frame 5, which embodies several advantageous improvements, transmits the weight of the user's arms, and the load that they are holding, to their torso and hips.

The cassette 7 has a substantially horizontal pivot axis A2 about which it can rotate, allowing relatively free but supported motion of the user's upper arm about the axis A2 within a vertical plane. The frame 5 has one or more substantially vertical pivot axes A1 to allow substantially free motion about the axis A1 within a horizontal plane. Axes A1 and A2 may intersect and/or may form a gimble centered on the user's shoulder.

The cassette 7 may contain one or more compensation elements (not shown) configured to apply an offset force to at least partially offset a gravitational force acting on the upper arm within the armrest 9, e.g. during vertical movement of the arm. For example, the compensation elements may include one or more springs or other resilient members (not shown) that are coupled between the cassette 7 and other components of the cassette 7 and/or frame 5 to provide the offset force. In various examples, the cassette 7 may include one or more pulleys and/or cables (also not shown) coupled to the resilient member(s) and/or otherwise configured to provide a desired force profile for the offset force, similar to the arm support systems in the patents referenced elsewhere herein.

In one example, the cassette 7 may be configured to provide a maximum offset force when the user's arm is fully extended, for example, in a substantially horizontal orientation, e.g., corresponding to when a user may be working with the arm extended for an extended period of time to reduce fatigue. The force profile may be reduced by the cassette above and below the substantially horizontal orientation, e.g., since less offset force may be needed as the arm is lowered. For example, the force profile may approach a zero offset force when the arm is lowered, e.g., to a substantially vertically downward orientation, e.g., corresponding to when the user has relaxed and simply lowered the arm.

Optionally, the cassette 7 may be detachable from the frame 5, for example, through a connection socket 8, which cooperates with a connection shaft 12 on the frame 5 to allow the cassette 7 to be attached to, or detached from, the frame 5, if desired. Optionally, the frame 5 may include multiple straps, e.g., a pair of shoulder straps and a hip belt (not shown), which may secure and hold the frame 5 on the user's torso and hips, one or more pads, e.g., shoulder pads, back pads, and the like, e.g., lumbar pad 60, to provide cushioning between the frame 5 and contact points on the user's body and/or otherwise increase comfort, and/or one or more covers (also not shown) overlying one or more of the components.

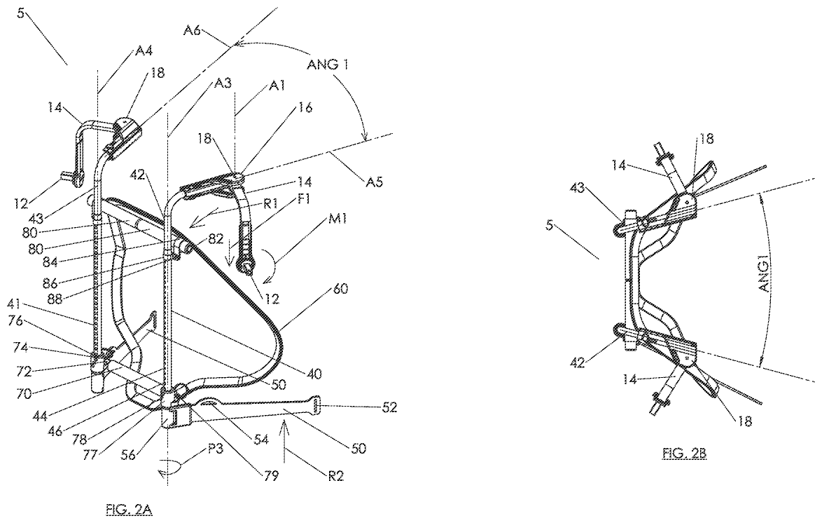

FIG. 2A shows a perspective view of the frame 5 with the cassettes and armrests detached. The straps, belt, and pads are not shown for clarity. The frame 5 includes a pair of dual telescoping spines, made up of outer spine tubes 40, 41, and inner spine tubes 42, 43. The outer spine tubes 40, 41 and inner spine tubes 42, 43 may be rigid or flexible, and be made of any practical material, such as steel, aluminum, plastic, composites, etc. Although the inner spine tubes 42, 43 are shown above the outer spine tubes 40, 41, it will be appreciated that they may be reversed if desired.

Pivot assemblies 18 are attached to upper ends of the (in this case inner) spine tubes 42, 43, and provide the pivoting cassette links 14 to which the cassette 7 (not shown) attaches. For example, horizontal bars may extend from the top of the inner spine tubes 42, 43, e.g., coupled by curved members such that the bars extend horizontally within a common plane offset by an angle ANG1, that carry the pivot assemblies 18, e.g., as shown in FIG. 2B. Optionally, the bars may be substantially rigid such that the angle ANG1 remains substantially unchanged even when the spine tubes 40-43 move when the frame 5 is worn, e.g., as the user moves, thereby maintaining the position of the pivot assemblies 18 relative to the user's shoulders, as described elsewhere herein.

Belt struts 50 are attached to lower ends of the lower (in this case outer) spine tubes 40, 41, and may pivot about spine axes A3 and A4, for example along path P3. The belt struts 50 may be rigid or flexible, selectively flexible, adjustably flexible, and/or may be made from any practical material, such as steel, aluminum, plastic, composite, etc. The belt struts 50 may also be rapidly replaced based on the needs for different characteristics (for example greater stiffness).

As shown in FIG. 2A, the cassette 7 (not shown) imparts moment MI and vertical force F1 to the frame 5 through connection shaft 12. The effect of moment MI and vertical force F1 is countered by reaction forces applied to the frame 5 by the user's torso and hips, resulting in static balance. For example, the user's back provides reaction force R1 acting on lumbar pad 60, and their hips provide reaction force R2 acting on belt strut 50. The assembly comprised of the interconnected elements of the cassette 7 (not shown), cassette link 14, pivot assembly 18, inner spine tube 42, outer spine tube 40, and belt strut 50 provides a load bearing structure that directs the weight of the user's arm past the shoulder, upper back, and lower back, and onto their hip. As described further below, the two spine assemblies can operate independently, allowing greater flexibility for the user, while still providing an efficient load bearing structure to direct load onto the user's hips.

Anti-rotation tube 70, cooperating with anti-rotation rods 72, maintains the desired fixed angle ANG1 between the axes A5 and A6 of the upper spine tubes 42 and 43 (and the pivot assemblies 18 attached to them), while allowing other types of relative motion between the two spine assemblies, as described further below. Lumbar pad reaction tubes 80 maintain the distance between the inner spine tubes 42 and 43 and the lumbar pad 60, thereby preventing uncomfortable contact between the inner spine tubes and the user's back. Alternatively, one or more pads, cushions, or other support members (not shown) may be provided to increase comfort to the user wearing the frame 5 in addition to or instead of the lumbar pad 60, e.g., to prevent the spine tubes 40-43 and/or tube 70 from pressing against the user's back.

When the user is in a neutral posture, with their back upright, the dual spine assemblies will typically be approximately parallel and at the same elevation. As disclosed below, additional degrees of freedom inherent in the frame 5 provide advantageous flexibility by allowing relative motion of the dual spine assemblies when needed by the user.

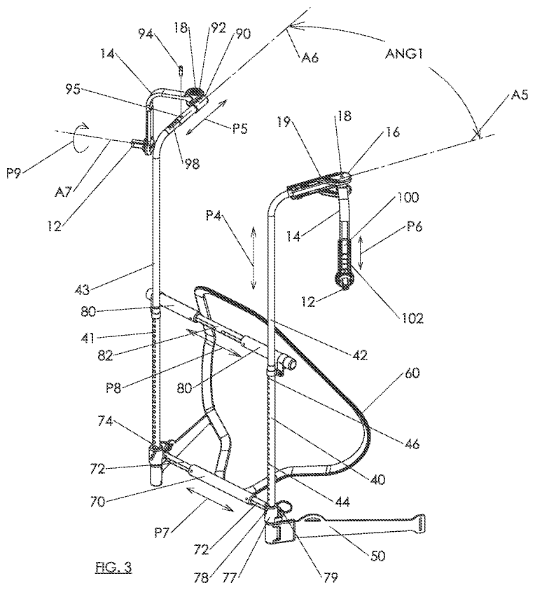

FIG. 3 shows a perspective view of the frame 5 with the basic adjustments used to fit the anatomy of the user displayed. For example, the distance between the two spines 40/42, 41/43 may be adjusted, approximately along paths P7 and P8, by tightening or loosening lateral straps (not shown). Anti-rotation tube 70 and anti-rotation rods 72 may separate (or proximate) approximately along path P7 to accommodate the distance between the spines, while continuing to maintain the fixed angle ANG1 (see, e.g., FIG. 2B). Lumbar pad reaction tubes 80 and lumbar pad reaction rod 82 also cooperate to accommodate the new distance between the spines by extending (or retracting) approximately along path P8, while continuing to maintain the distance between the inner spine tubes 42 and 43 and the lumbar pad 60. The length of the dual spines may be adjusted, e.g., in the manner of common telescoping tube structures, e.g., by depressing a lock button 46, sliding the inner spine tube 42 approximately along path P4 to align with a desired hole 44 in the outer spine tube 40, and letting the button 46 resile into the new hole. Alternatively, other locking mechanisms may be provided to secure the spines at desired lengths, e.g., providing continuous adjustment or adjustment to one of a plurality of available lengths. For example, the inner ends of the inner spine tubes 42, 43 within the outer spine tubes 40, 41 may include cam locks or other features that may be rotated to engage or release the inner end against the inner walls of the outer spine tubes 40, 41.

Optionally, each pivot assembly 18 may be adjusted approximately horizontally along the respective inner spine tube 42, 43, e.g., to accommodate the depth of the user's torso. For example, the pivot assembly 18 (with cover 19 removed) can be adjusted along inner spine tube 43 approximately along path P5 by removing pin 94, aligning a desired hole 98 in the inner spine tube 43 with the hole 95 in pivot assembly 18, and re-inserting the pin 94. Alternatively, other locking mechanisms may be provided to secure the pivot assemblies 18 at desired horizontal distances relative to the spine tubes 42, 43.

In addition or alternatively, the height of the cassette connection shaft 12 can be adjusted by moving cassette link extension 100 approximately along path P6 to align it with the user's shoulder and/or the angle of the cassette connection shaft 12 can be adjusted to vary the elevation of the cassette 7 (not shown). For example, the angle of cassette connection shaft 12 can be adjusted about axis A7 approximately along path P9. The fixed angle ANG1 between axes A5 and A6 of the upper spine tubes 42 and 43 may be changed, for example by removing pin 79 from hole 78 in angle hub 77 and reinserting it in another hole (not shown) to change the angle.

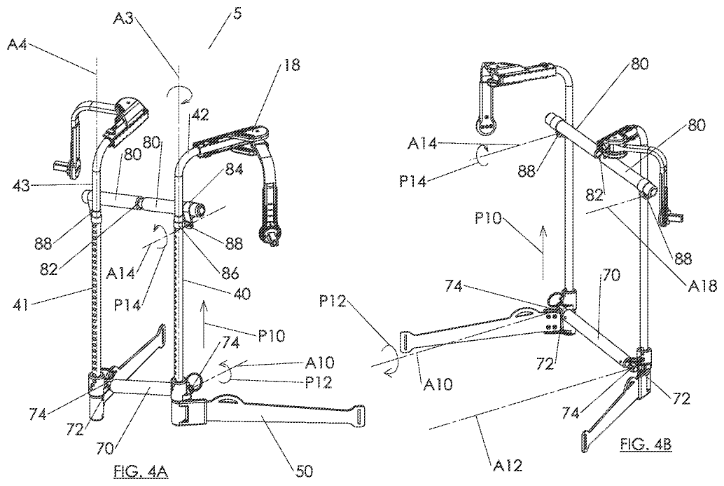

FIG. 4A shows a perspective view of the frame 5, with the lumbar pad 60 removed for clarity. The right spine assembly, comprising pivot assembly 18, inner spine tube 42, outer spine tube 40, and belt strut 50, is shown displaced in the vertical direction relative to the left spine assembly approximately along path P10. This ability provides an advantageous additional degree of freedom, improving the flexibility of the frame 5, while maintaining its ability to effectively transmit load to the user's torso and hips. The anti-rotation tube 70 and anti-rotation rods 72 may pivot about their pivots 74, for example along path P12 about axis A10. Similarly, the lumbar pad reaction tubes 80 and lumbar reaction rods 82 are free to pivot about their pivots 88, for example, along path P14 about axis A14. The ability of one spine assembly to move relative to the other is similar to well understood four-bar-linkage mechanisms, in which four links are joined with pivots.

FIG. 4B shows a different perspective view of the frame 5 as shown in FIG. 4A, to clarify the locations of the pivots 74 and pivots 88 that permit the relative motion of the two spine assemblies.

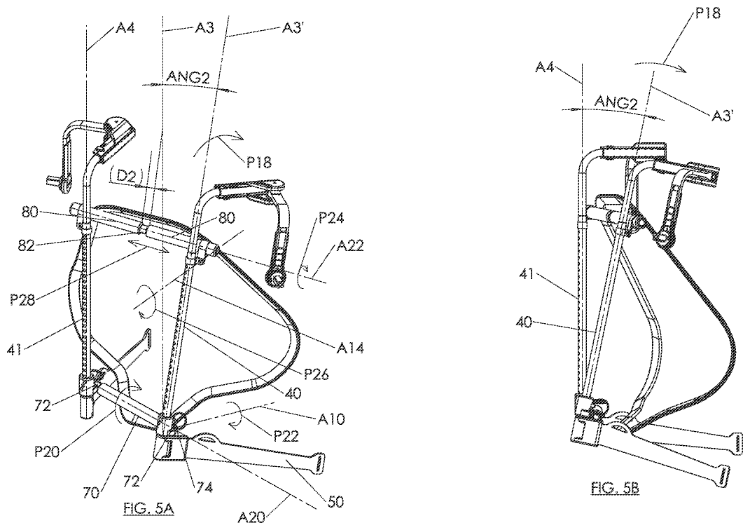

FIG. 5A shows a perspective view of the frame 5 demonstrating another advantageous degree of freedom. The right spine assembly, comprising pivot assembly 18, inner spine tube 42, outer spine tube 40, and belt strut 50, is shown displaced in the forward direction relative to the left spine assembly approximately along path P18. Spine assembly axes A3 and A4 are shown non-parallel, with the right spine assembly axis A3′ at an angle ANG2 relative to its neutral substantially vertical axis A3. The anti-rotation tube 70 has rotated about anti-rotation rods 72 about axis A20, approximately along path P20. Similarly lumbar pad reaction tubes 80 may rotate on lumbar reaction rods 82 about axis A22, approximately along path P24. The ability of the anti-rotation tube 70 and anti-rotation rods 72 to extend and retract (see FIG. 3), and the ability of the lumbar pad reaction tubes 80 and lumbar pad reaction tube 82 to extend and retract (see FIG. 3), further adds to the flexibility of the frame 5. For example, the lumbar pad reaction tubes 80 are shown separated approximately along path P28 by distance D2, permitting the angle ANG2 to be achieved without effort on the part of the user. Further flexibility can be achieved if the straps that adjust the distance between the dual spines, and the shoulder straps and belt are elastic.

FIG. 5B shows a side view of the frame 5 in FIG. 5A, further clarifying the relative angle ANG2 between the two spine assemblies.

The relative motions of the dual spines that are described above (i.e., the additional degrees of freedom available) may occur simultaneously or independently. An example of these two degrees of freedom being utilized simultaneously is a user twisting at the waist while also bending at the waist. In such a case, one spine assembly might elevate relative to the other, while simultaneously tilting forward relative to the other. An example of only one degree of freedom being utilized is climbing a ladder, where the hips articulate in a way to raise one spine assembly relative to the other, but the two spine assemblies remain substantially parallel.

The ability of the two spine assemblies to move relative to each other, while still efficiently transmitting loads past the user's shoulder and back, results in a frame that has additional flexibility without compromising the structure needed to protect the user's shoulders and back.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the scope of the appended claims.

1. A frame for an exoskeleton, comprising:
a pair of elongate spine members comprising lower ends and upper ends, each aligned generally along respective vertical axes;
pivot assemblies extending from the upper ends of respective spine members such that the pivot assemblies define horizontal axes;
an anti-rotation member pivotally coupled to the lower ends of the spine members to prevent the horizontal axes from changing horizontally as the spine members move; and
a lumbar reaction member pivotally coupled to the upper ends of the spine members to provide a linkage that accommodates movement of a user wearing the frame while transferring loads from the pivot assemblies to the torso of the user.

2. The frame of claim 1, further comprising shoulder brackets coupled to respective pivot assemblies such that the shoulder brackets rotate about a vertical axis within a generally horizontal plane to accommodate movement of an arm support coupled to the shoulder bracket.

3. The frame of claim 2, wherein each of the shoulder brackets includes a lower end comprising a connector for coupling an arm support to the shoulder bracket.

4. The frame of claim 3, further comprising an arm support comprising a connector for coupling to the connector on the lower end of one of the shoulder brackets.

5. The frame of claim 2, further comprising an arm support coupled to a lower end of the shoulder bracket such that the arm support is pivotable about the vertical axis.

6. The frame of claim 4, wherein the arm support comprises a cassette pivotable about a second axis orthogonal to the vertical axis and an armrest for receiving an upper arm of the user, the cassette including one or more compensation elements configured to apply an offset force to at least partially offset a gravitational force acting on the upper arm within the armrest during vertical movement about the second axis.

7-8. (canceled)

9. The frame of claim 1, further comprising one or more belt straps coupled to the lower ends of the spine members to secure the lower ends to the torso of the user.

10. The frame of claim 1, wherein the spine members are movable axially to adjust a distance between the upper and lower ends, the spine members comprising locking elements to secure the spine members with the upper and lower ends at one or more distances.

11. The frame of claim 10, wherein the spine members comprise telescoping members that are movable relative to one another to adjust the distance.

12. The frame of claim 1, wherein the anti-rotation member comprises opposite ends coupled to the opposite lower ends of the spine members, the opposite ends movable to adjust a distance between the opposite lower ends, the anti-rotation member comprising one or more locking elements to secure the anti-rotation member with the opposite lower ends spaced apart at one or more distances.

13. The frame of claim 1, wherein the lumbar reaction member comprises a plurality of members slidable axially in a direction orthogonal to the vertical axes to change a distance between the upper ends as the user moves to accommodate the movement.

14. The frame of claim 1, wherein the horizontal axes of the first and second pivot assemblies are nonparallel with one another.

15. The frame of claim 14, further comprising a locking mechanism for adjusting and securing the horizontal axes of the first and second pivot assemblies at one or more nonparallel angles.

16. A frame for an exoskeleton, comprising:
a pair of elongate spine members comprising lower ends and upper ends aligned generally along vertical axes;
a pivot assembly extending from an upper end of a first spine member of the elongate spine members such that the pivot assembly defines a horizontal axis;
an anti-rotation member pivotally coupled to the lower ends of the spine members to prevent the spine members from rotating about the vertical axes to prevent the horizontal axis from changing horizontally as the spine members move;
a lumbar reaction member pivotally coupled to the upper ends of the spine members to provide a linkage that accommodates movement of a user wearing the frame while transferring loads from the pivot assemblies to the torso of the user; and
a shoulder bracket coupled to the pivot assembly such that the shoulder bracket rotates about a vertical axis within a generally horizontal plane to accommodate movement of an arm support coupled to the shoulder bracket.

17. The frame of claim 16, wherein each of the shoulder brackets includes a lower end comprising a connector for coupling an arm support to the shoulder bracket.

18. The frame of claim 17, further comprising an arm support comprising a connector for coupling to the connector on the lower end of one of the shoulder brackets.

19-20. (canceled)

21. The frame of claim 1, wherein each of the spine members comprises a substantially rigid or semi-rigid strut defining the upper and lower ends of the respective spine members.

22. The frame of claim 21, wherein the spine members comprise telescoping members that are movable relative to one another to adjust a distance between the upper and lower ends.

23. The frame of claim 1, wherein each spine member is configured to transfer loads from an arm support coupled to each pivot assembly to the lumbar reaction member independent of the other spine member.

24. An arm support system, comprising:
an exoskeleton including a frame comprising a pair of elongate spine members comprising lower ends and upper ends aligned generally along vertical axes; a first pivot assembly extending from the upper end of a first spine member such that the first pivot assembly defines a horizontal axis; an anti-rotation member pivotally coupled to the lower ends of the spine members to prevent the horizontal axis from changing horizontally as the spine members move; and a lumbar reaction member pivotally coupled to the upper ends of the spine members to provide a linkage that accommodates movement of a user wearing the frame while transferring loads from the pivot assemblies to the torso of the user;
a first shoulder bracket coupled to the first pivot assembly such that the first shoulder bracket rotates within a generally horizontal plane;
a first arm support comprising an arm rest and coupled to the first shoulder bracket such that the first arm support rotates within a generally vertical plane to accommodate vertical movement of an arm within the arm rest; and
one or more compensation elements coupled to the first arm support to apply an offset force to at least partially offset a gravitational force acting on the arm within the arm rest during vertical movement of the arm and the first arm support follows the movement of the user's arm.

25-42. (canceled)
